(19) United States
(12) Patent Application Publication
(10) Pub. No.: US 2025/0212254 A1
(43) Pub. Date: Jun. 26, 2025

(54) PREEMPTION WITH CTS TAKEOVER

(71) Applicant: Cisco Technology, Inc., San Jose, CA (US)

(72) Inventors: Matthew A. SILVERMAN, Shaker Heights, OH (US); Brian D. HART, Sunnyvale, CA (US); Binita GUPTA, San Diego, CA (US); Malcolm M. SMITH, Richardson, TX (US)

(21) Appl. No.: 18/662,867

(22) Filed: May 13, 2024

Related U.S. Application Data
(60) Provisional application No. 63/614,495, filed on Dec. 22, 2023.

(51) Int. Cl. H04W 74/0816; H04W 74/08

(52) U.S. Cl. CPC H04W 74/0816; H04W 74/0875

(57) ABSTRACT

Embodiments herein employ changes to the physical layer of an RTS/CTS protocol to preempt a pending TxOp so that a higher priority TxOp can occupy the wireless network. In the protocol, the AP sends out a physical frame containing an RTS frame indicating that it allows its TxOp to be preempted by a station having a TxOp with higher priority. The physical frame containing the RTS frame can give the indication in various ways. In some embodiments, the RTS can be an MU-RTS, which allows multiple stations to preempt the TxOp. In response to the RTS, one or more stations send a physical frame containing a CTS frame indicating that at least one station will preempt the TxOp. Upon receiving the physical frame containing the CTS frame, the AP yields to the preempting station or stations.

### CROSS-REFERENCE TO RELATED APPLICATIONS

This application claims benefit of co-pending U.S. provisional patent application Ser. No. 63/614,495 filed Dec. 22, 2023. The aforementioned related patent application is herein incorporated by reference in its entirety.

### TECHNICAL FIELD

Embodiments presented in this disclosure generally relate to controlling traffic in a Wi-Fi network. More specifically, embodiments disclosed herein relate to providing preference to higher-priority traffic and postponing lower-priority traffic in the Wi-Fi network.

### BACKGROUND

In Wi-Fi networks, the medium is shared among one or more access points and one or more stations. The access points and the stations contend for the use of the medium according to a distributed coordination function. However, the contention does not guarantee that higher-priority traffic can use the medium before lower-priority traffic. Even quality of service (QOS) indicators in the traffic do not guarantee that the delivery of higher-priority, highly sensitive traffic is without interruption, especially if a long low-priority data transmission currently occupies the medium. Thus, there is a need to postpone the low-priority traffic before it can occupy the medium and use the medium for highly sensitive traffic.

### BRIEF DESCRIPTION OF THE DRAWINGS

FIG. 1 depicts an extended service set (ESS) infrastructure, according to embodiments.

FIG. 2 depicts a representative access point (AP), according to embodiments.

FIG. 3 depicts a single-user request-to-send/clear-to-send (SU RTS/CTS) exchange, according to embodiments.

FIG. 4 depicts an RTS frame and a CTS frame, according to embodiments.

FIG. 5 depicts a multi-user (MU)-RTS/CTS exchange, according to embodiments.

FIG. 6 depicts a MU-RTS frame and a CTS frame, according to embodiments.

FIG. 7 depicts a physical frame with a legacy signal (L-SIG), a high-throughput signal (HT-SIG), and a service field, according to embodiments.

FIG. 8 depicts a flow of operations for single-user preemption, according to embodiments.

FIG. 9 depicts a flow of operations for sending a physical frame containing an RTS frame indicating preemption is allowed, according to embodiments.

FIG. 10 depicts a flow of operations for receiving a physical frame containing a CTS frame from the preempting station, according to embodiments.

FIG. 11 depicts a flow of operations for multi-user preemption, according to embodiments.

FIG. 12 depicts a flow of operations for sending a physical frame containing the RTS frame of a selected preemption type, according to embodiments.

FIG. 13 depicts a flow of operations for receiving a physical frame containing a CTS frame in response to the MU-RTS frame.

### DESCRIPTION OF EXAMPLE EMBODIMENTS OVERVIEW

One embodiment presented in this disclosure is a method for preempting a transmission opportunity (TxOp). The method includes sending, from an access point (AP), a request-to-send (RTS) frame to a plurality of stations, the AP having a pending transmission opportunity (TxOp), where a physical frame containing the RTS frame indicates that the AP allows having its pending TxOp to be preempted by at least one station of the plurality of stations having a TxOp with a priority higher than the pending TxOp to transfer, and receiving a physical frame containing a clear-to-send (CTS) frame from at least one station of the plurality of stations, where the physical frame containing the CTS frame indicates that at least one station is preempting the TxOp of the AP.

Another embodiment is an access point that includes a processor and a memory coupled to the processor and having loaded therein a program which, when executed by the processor, is configured to: send, from an access point (AP), a request-to-send (RTS) frame to a plurality of stations, the AP having a pending transmission opportunity (TxOp), where a physical frame containing the RTS frame indicates that the AP allows having its pending TxOp to be preempted by at least one station of the plurality of stations having a TxOp with a priority higher than the pending TxOp to transfer, and receive a physical frame containing a clear-to-send (CTS) frame from at least one station of the plurality of stations, where the physical frame containing the CTS frame indicates that at least one station is preempting the TxOp of the AP,

Yet another embodiment is a non-transitory computer-readable medium encoding instructions, which, when executed by a processor of an access point coupled to a wireless medium, cause the access point to send, from an AP, a request-to-send (RTS) frame to a plurality of stations, the AP having a pending transmission opportunity (TxOp), where a physical frame containing the RTS frame indicates that the AP allows having its pending TxOp to be preempted by at least one station of the plurality of stations having a TxOp with a priority higher than the pending TxOp to transfer, and receive a physical frame containing a clear-to-send (CTS) frame from at least one station of the plurality of stations, where the physical frame containing the CTS frame indicates that at least one station is preempting the TxOp of the AP.

### EXAMPLE EMBODIMENTS

Wireless networks generally provide a contention-based service under the control of a distributed coordination function (DCF) because only a single broadcast medium is available to stations and access points. However, the medium can often be reserved for large data transfers so that the large transfer can occur free from contention and interruption using the RTS/CTS protocol. In embodiments described herein, the RTS/CTS protocol is extended to allow pending TxOps to be postponed or preempted until after a higher priority TxOp is completed. This extended protocol makes the wireless network more responsive to high-priority, low-latency traffic.

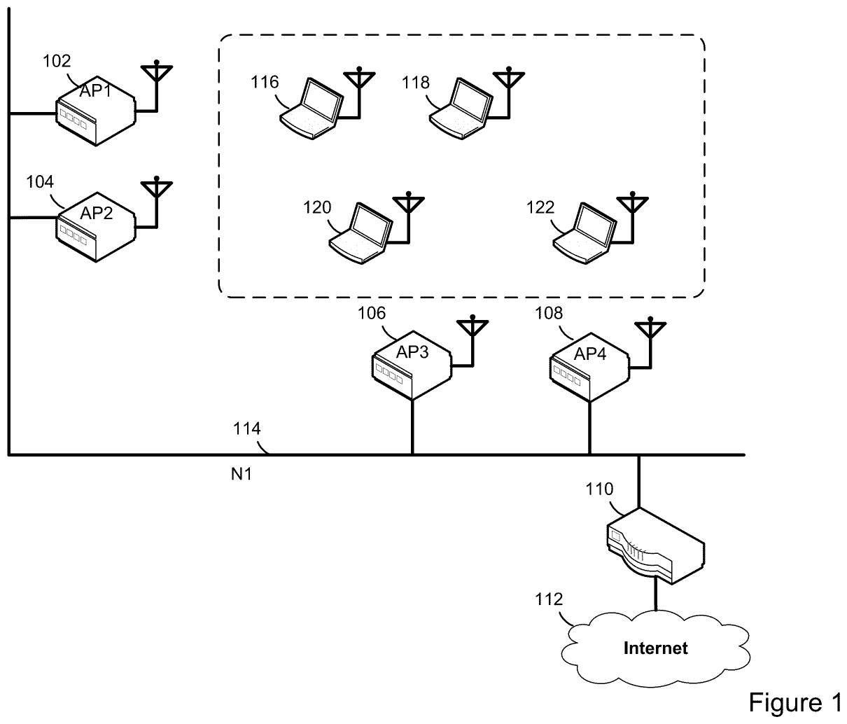

FIG. 1 depicts an extended service set (ESS) infrastructure, according to embodiments. The ESS includes AP 1 (102), 2 (104), 3 (106), and 4 (108), stations 1(116), 2 (118), 3 (120), and 4 (122), all coupled together with a wired network N1 114. The network N1 114 is coupled to a router 110, which in turn is coupled to the Internet 112.

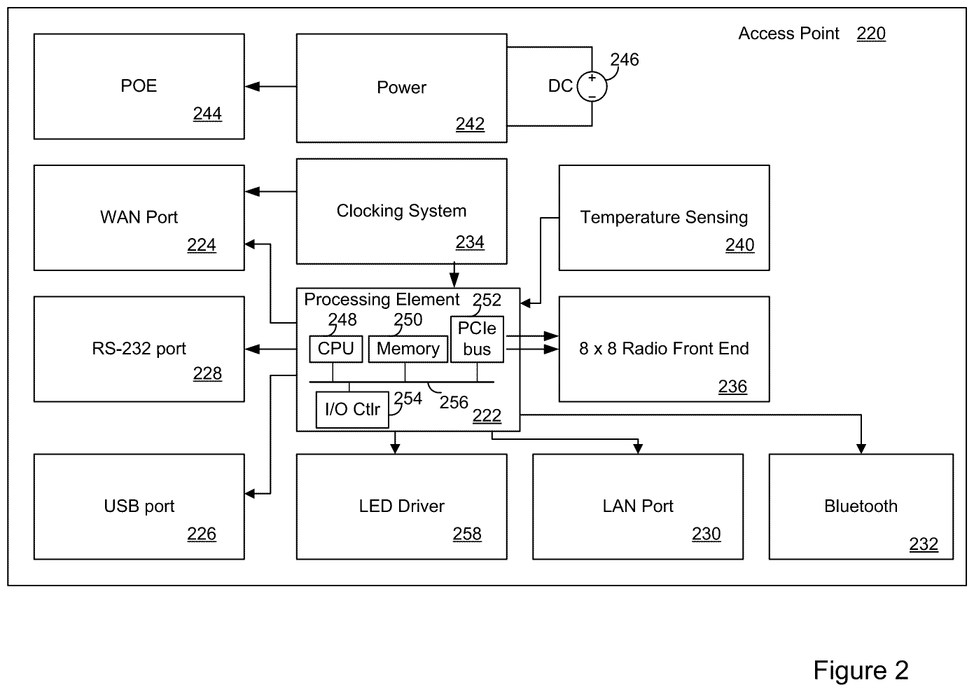

FIG. 2 depicts a representative architecture of an AP, according to embodiments. The AP 220 includes a processing element 222 and several ports or connection facilities, such as a WAN port 224, USB port 226, RS-232 port 228, LAN port 230, and Bluetooth 232. Also included are a clocking system 234 and an 8×8 radio front-end 236 with a transmitter and receiver, which are coupled to eight external antennas. Auxiliary modules include a temperature sensing module 240, a power module 242 connected to a DC power source 246, a power over Ethernet (POE) module 244, and LED driver 258. The processing element 222 includes a CPU 248 and memory 250, a peripheral control interconnect express (PCIe) bus controller 252 for connecting to the 8×8 radio front-end 236, and an I/O controller 254, all coupled to each other via bus 256. Memory 250 may include one or more buffers for traffic entering or exiting AP 220.

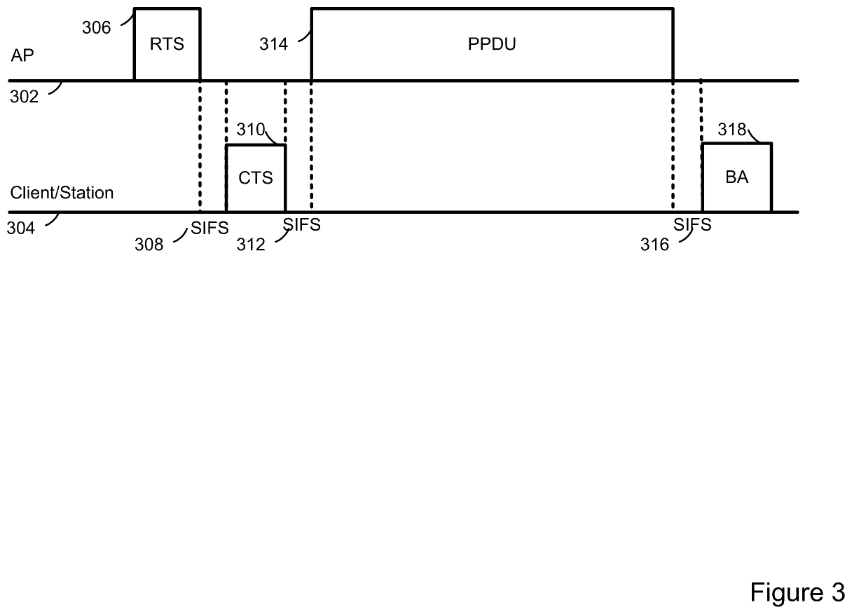

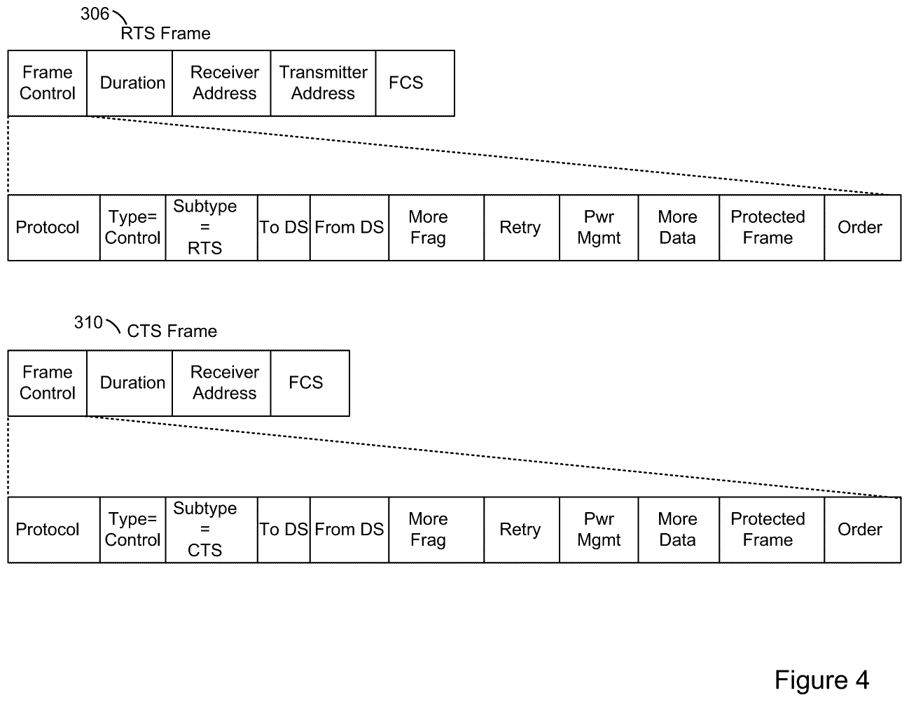

FIGS. 3-6 depict request-to-send, clear-to-send (RTS/CTS) protocols and frames for single-user and multi-user cases. The various fields in the RTS and CTS frames are shown in FIGS. 4, 6, and 7. Some of these fields, as described below, are used in an extended protocol to indicate whether preemption is allowed.

FIG. 3 depicts a single-user (SU) RTS/CTS exchange. In the access point (AP) timeline 302, the AP sends an RTS frame 306, which is answered by a CTS frame 310 after a short interframe space (SIFS) 308 in the client or station timeline 304. Upon receipt of the CTS frame 310, the AP waits for a SIFS 312 and then sends a physical protocol data unit (PPDU) 314. After the PPDU, the client waits for a SIFS 316 and sends a block acknowledgment (BA) frame 318.

FIG. 4 depicts an RTS frame and a CTS frame, according to embodiments. The RTS frame 306 is conventionally used to gain control of the medium for the transmission of ‘large’ frames, where ‘large’ is defined by the RTS threshold in the network card driver. Access to the medium is reserved for unicast frames. In one embodiment, the RTS frame 306 has only a header; no data is transmitted in the body. The RTS frame 306 includes a frame control field, a duration field, a receiver address, a transmitter address, and a frame check sequence (FCS). The frame control field includes a protocol field, a type field, which is set to identify the frame as a control frame, a subtype field, which is set to indicate an RTS frame, a “to DS” field, and a “from DS” field, a more fragments field, a retry field, a power management field, a more data field, a protected frame field, and an order field.

The CTS frame 310 includes a frame control field, a duration field, a receiver address field, and an FCS. The frame control field is the same as that for the RTS frame 306, except that the subtype field indicates a CTS frame instead of an RTS frame 306. The CTS frame 310 has two purposes: as a response to an RTS frame 306 and as a protection mechanism to avoid interfering with older stations.

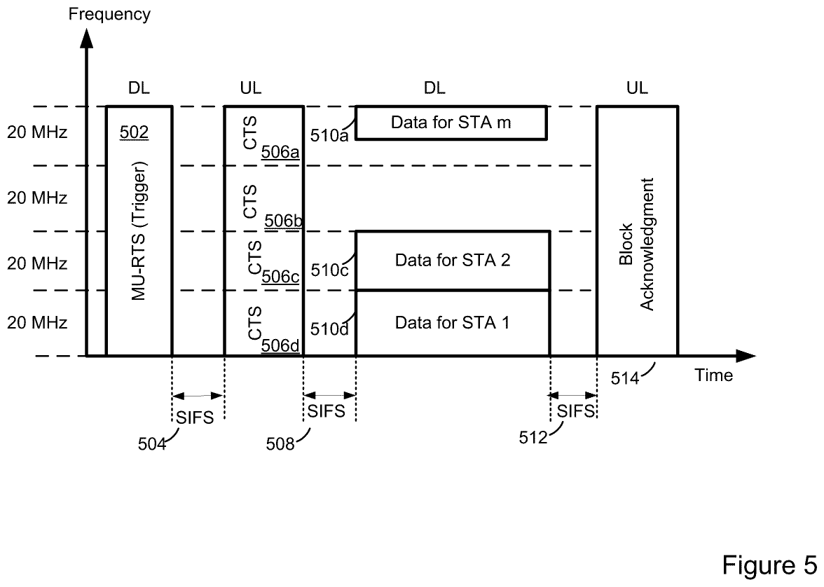

FIG. 5 depicts a multi-user (MU) RTS/CTS exchange, according to embodiments. In a downlink transmission, the AP sends an MU-RTS frame 502 (a type of trigger frame) to multiple stations. After a short interframe spacing (SIFS) 504, each station receiving the MU-RTS frame 502 responds with a CTS frame 506a-d. After another SIFS 508, the AP sends data 510a-d to each station. Following another SIFS 512, a BA 514 is sent to the AP.

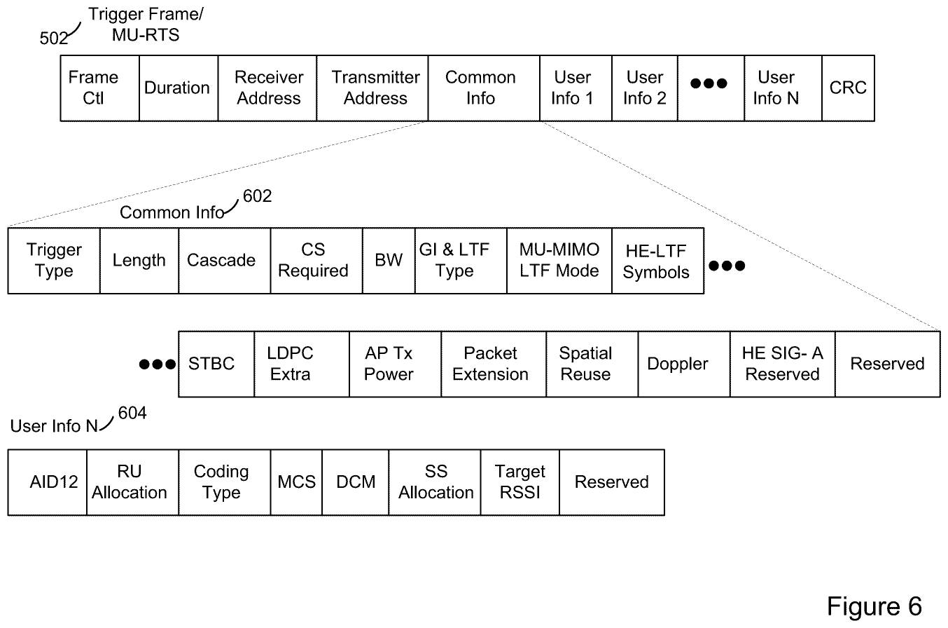

FIG. 6 depicts an MU-RTS frame 502, according to embodiments. The MU-RTS frame 502 includes a frame control field, a duration field, a receiver address, a transmitter address, a common info field 602, and up to N user info fields 604, all followed by a cyclical redundancy code (CRC). The common info field includes a trigger type field, a length field, a cascade field, a carrier sense (CS) required field, a bandwidth (BW) field, a guard interval and long training (GI&LTF) field, a multi-user, multiple input, multiple output long training field (MU-MIMO LTF) mode field, the number of high-efficiency long training field (HE-LTF) symbols, a space-time block coding (STBC) field, a low-density parity-check code (LDPC) extra field, an AP transmit (Tx) power field, a packet extension field, a spatial reuse field, a Doppler field, a high-efficiency (HE) SIG-A reserved field, and a reserved field. Each user info field includes the least significant bits of the identification number of the station (AID12), a resource unit (RU) allocation field, a coding type field, a modulation and coding set (MCS) field, a dual-carrier modulation (DCM) field, a spatial stream (SS) allocation field, a target received signal power (RSSI) field, and a reserved field.

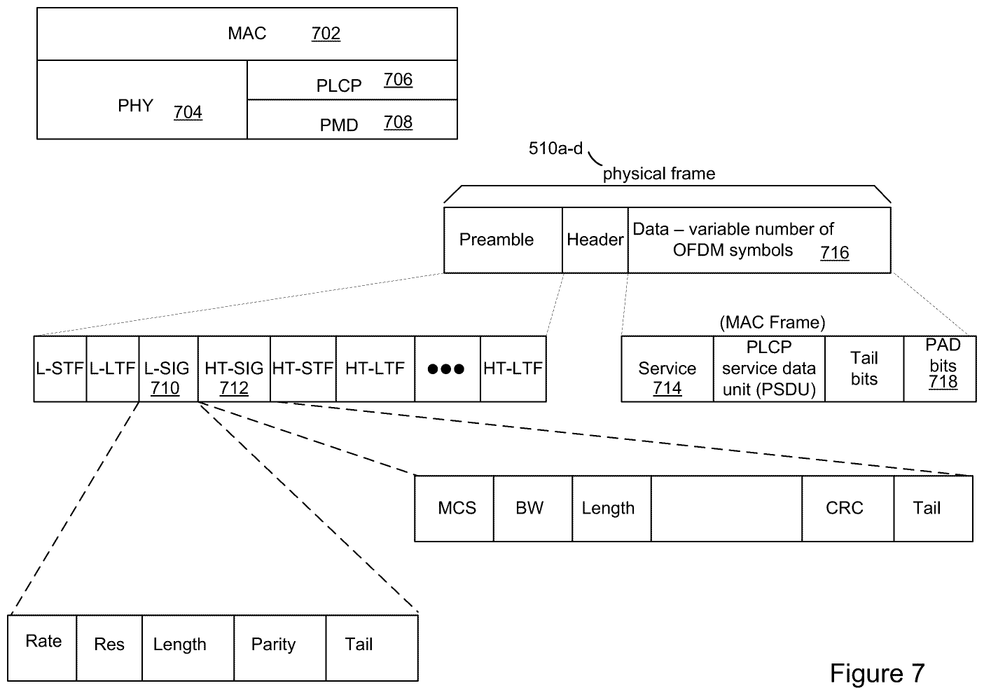

FIG. 7 depicts a physical frame with an L-SIG, an HT-SIG, and a service field, according to embodiments. The physical frame 510a-d includes a preamble, header, and data. In the preamble, the legacy signal (L-SIG) field 710 includes a rate field, a reserved field, a length field, a parity field, and a tail field. Further in the preamble, the high-throughput signal (HT-SIG) field 712 includes a modulation and coding set (MCS) field, a bandwidth (BW) field, a length field, a cyclical redundancy check (CRC) field, and a tail field. The DATA field 716 of the physical frame 510a-d frame includes a service field, the physical layer convergence procedure (PLCP) service data unit (PSDU), the tail, and a pad. The network layer hierarchy is also depicted with the MAC layer 702 on top of the physical layer 704. The PLCP layer 706 and PMD layer 708 are part of the physical layer 704.

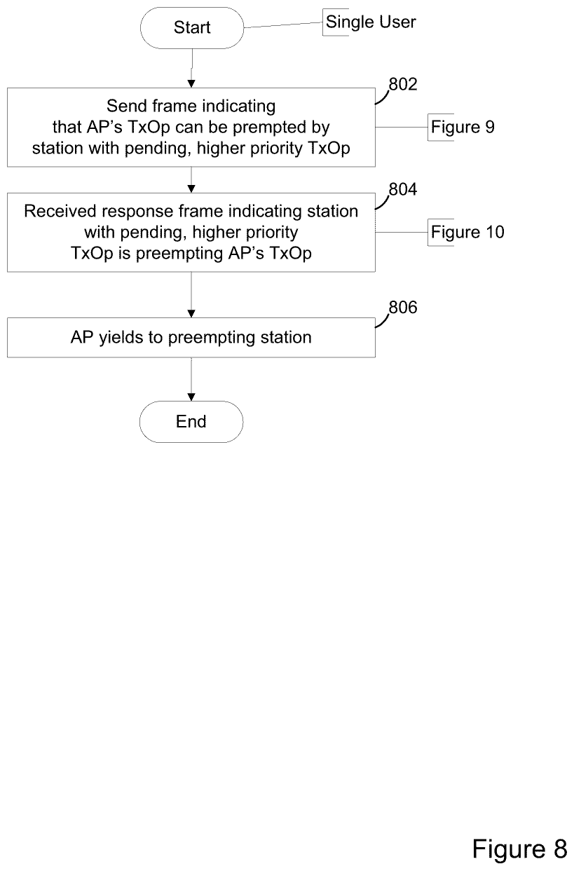

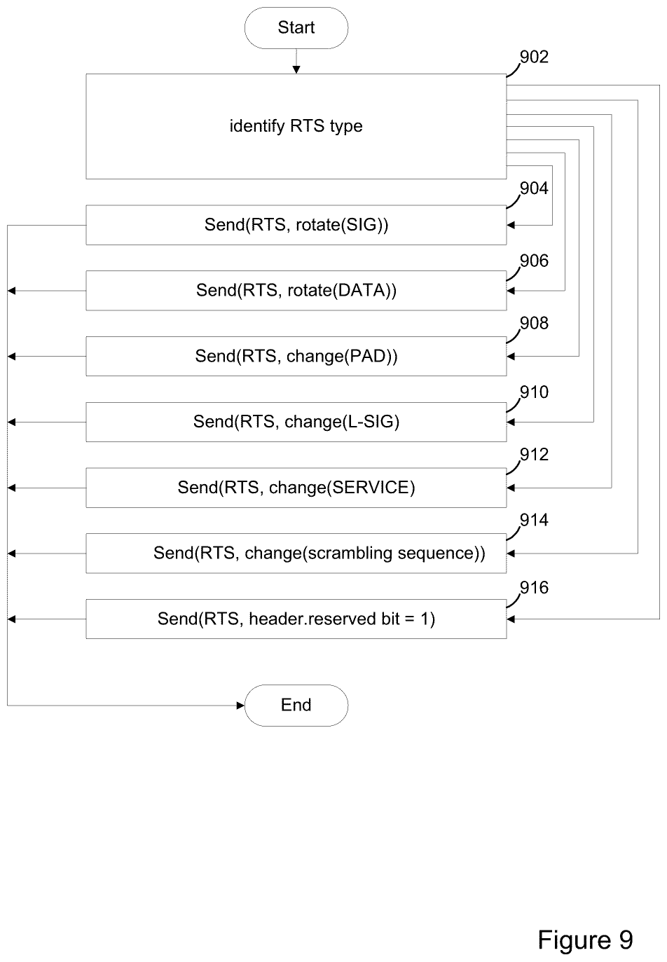

FIG. 8 depicts a flow of operations for single-user preemption, according to embodiments. In block 802, the AP broadcasts a frame to all stations indicating that the AP's TxOp can be pre-empted by a pending, higher-priority TxOp. Block 802 is described in more detail in FIG. 7. In block 804, the AP receives a response frame indicating that a station with a pending, higher priority TxOp is pre-empting AP's TxOp. Block 804 is described in more detail in FIG. 9. In block 806, the AP yields to the preempting station. That is, instead of the AP using the TxOp to transmit its data, the TxOp is assigned to the station.

FIG. 9 depicts a flow of operations for sending a physical frame containing an RTS frame indicating preemption is allowed, according to embodiments. The flow of operations depicts different ways of implementing block 802 in FIG. 8, i.e., of notifying the infrastructure that the AP TxOp can be preempted. The selection of type depends in part on the ease of implementation. In block 902, the AP identifies a particular type of RTS frame whose corresponding physical frame is altered to indicate that the AP TxOp can be pre-empted. In block 904, the AP sends a first type of RTS frame in which the corresponding physical frame SIG field is rotated. In one embodiment, the rotation is ±15-45 degrees rotation of the data subcarriers. In block 906, the AP sends a second type of RTS frame in which the corresponding physical frame DATA field 716 is rotated. In one embodiment, the rotation is ±15-45 degrees rotation of the data subcarriers. In block 908, the AP sends a third type of RTS frame in which the corresponding physical frame PAD field 718 is altered. In block 910, the AP sends a fourth type of RTS frame in which the corresponding physical frame L-SIG field 710 is altered. In block 912, the AP sends a fifth type of RTS frame in which the corresponding physical frame SERVICE field 714 is altered. Alternatively, in block 914, the scrambling sequence of the scrambler, which encodes the frame, is altered. In block 916, the AP sends a sixth type of RTS frame in which the reserved bit in the corresponding physical frame header is set to a 1.

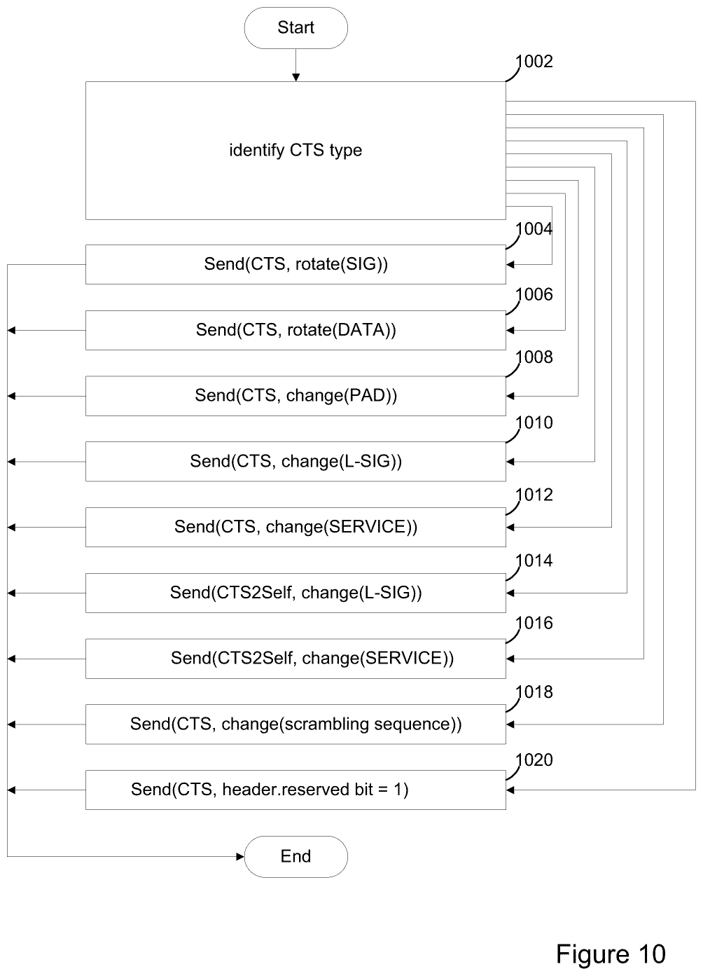

FIG. 10 depicts a flow of operations for receiving a physical frame containing a CTS frame from the preempting station, according to embodiments. FIG. 10 provides detail for block 804 in FIG. 8. In block 1002, the station identifies a CTS type for the response to the received RTS. Responses include altering one or more various fields in the physical frame preamble, header, or data. In block 1004, the station sends a CTS frame in which the SIG field in the corresponding physical frame is rotated. In one embodiment, the rotation is ±15-45 degrees rotation of the data subcarriers. In block 1006, the station sends a CTS frame in which the physical frame DATA field 716 is rotated. In one embodiment, the rotation is ±15-45 degrees rotation of the data subcarriers. In block 1008, the station sends a CTS frame in which the physical frame PAD field 718 is altered. In block 1010, the station sends a CTS frame in which the physical frame L-SIG field 710 is altered. In block 1012, the station sends a CTS frame in which the physical frame SERVICE field 714 is altered. In block 1014, the station sends a CTS2Self frame in which the physical frame L-SIG field 710 is altered. In block 1016, the station sends a CTS2Self frame in which the physical frame SERVICE field 714 field is altered. Alternatively, in block 1018, the station sends a CTS frame in which the scrambling sequence of the scrambler, which encodes the stream, is altered. In block 1020, the station sends a CTS frame in which the reserved bit in the physical frame header is set to a 1.

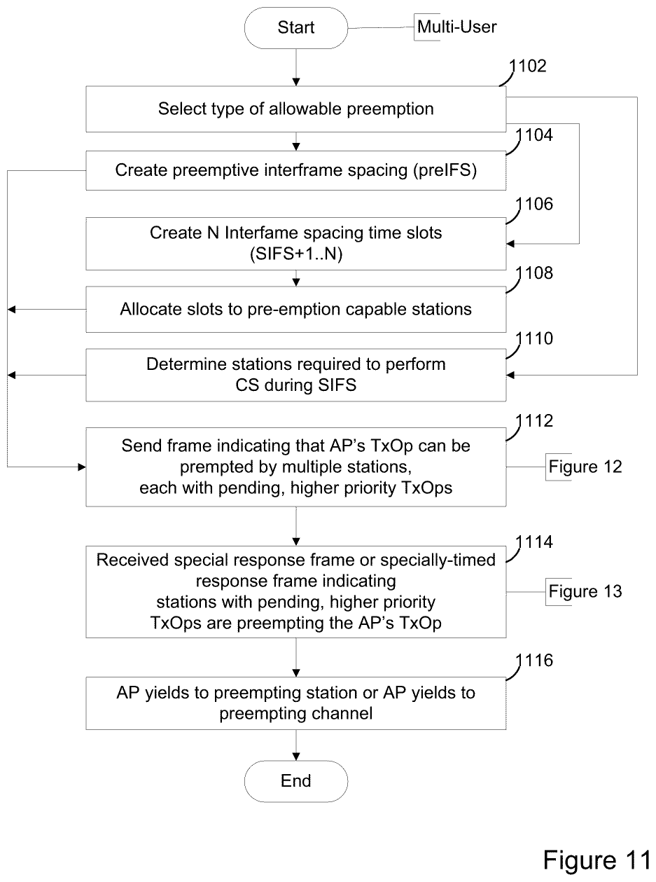

FIG. 11 depicts a flow of operations for multi-user preemption, instead of single-user preemption described in FIGS. 8-10, according to embodiments. In block 1102, the AP creates a preemptive interframe spacing (preemptive IFS or preIFS), shorter than a short interframe spacing (SIFS), for the infrastructure to indicate that preemption is allowed. Creating the preIFS entails setting the distributed coordination function (DCF) in the AP and stations of the infrastructure. Similarly, in block 1104, the AP creates a number N of short interframe spacing slot times (SIFS+1 . . . N) via the DCF. In block 1108, the AP allocates N interframe spacing slot times to N preemption-capable stations so that up to N stations have permission to preempt the AP's TxOp without conflict. In block 1110, the AP determines the stations required to perform carrier sense (CS) during SIFS. In block 1112, the AP sends a frame to all of the stations in the infrastructure, according to the selected preemption type, indicating the AP's TxOp can be preempted by multiple stations, each with pending higher priority TxOps. Block 1112 is described in more detail in reference to FIG. 10.

In block 1114, the AP receives a special response frame or a specially-timed response frame, depending on the type of allowable preemption, indicating stations with pending, higher-priority TxOps are preempting the AP's TxOp, where a specially-timed frame is one using the prelFS or one of the N SIFS slot times and a special response frame is one other than the specially-timed frame. Block 1114 is described in more detail in reference to FIG. 11. In block 1116, the AP yields to the preempting station or the preempting channel.

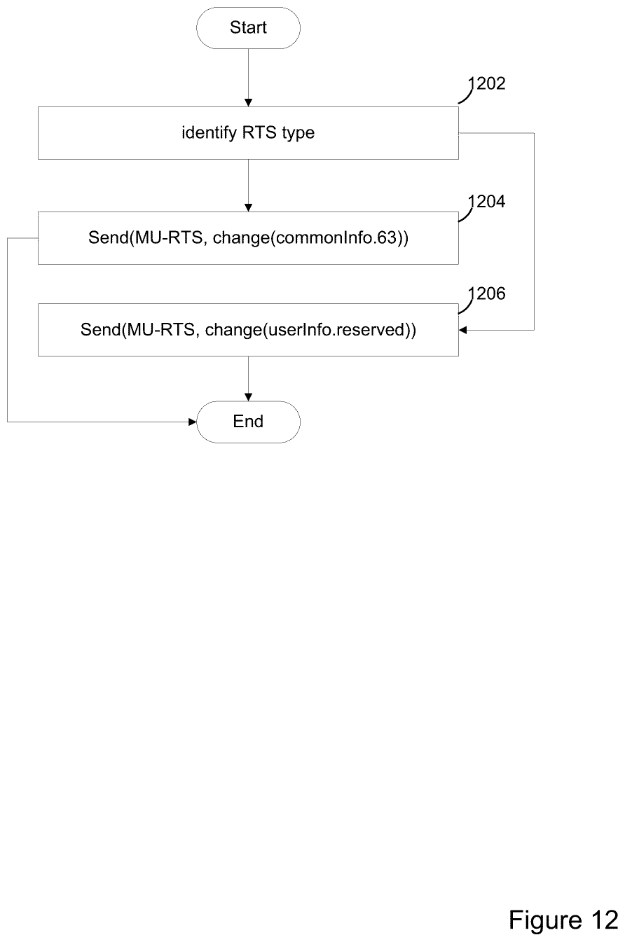

FIG. 12 depicts a flow of operations for sending a physical frame containing the RTS frame of a selected preemption type, according to embodiments. The flow of operations provides detail in implementing block 1112 in FIG. 11, where the RTS frame transmitted by the AP indicates the AP's TxOp can be preempted by multiple stations, each with pending higher priority TxOps. In block 1202, the AP identifies the RTS type to be used to indicate that preemption is allowed. In block 1204, the AP sends a MU-RTS frame with bit 63 of the common info field altered to indicate that preemption is allowed. In block 1206, the AP sends a MU-RTS frame with the reserved field of the userInfo field altered to indicate that preemption is allowed.

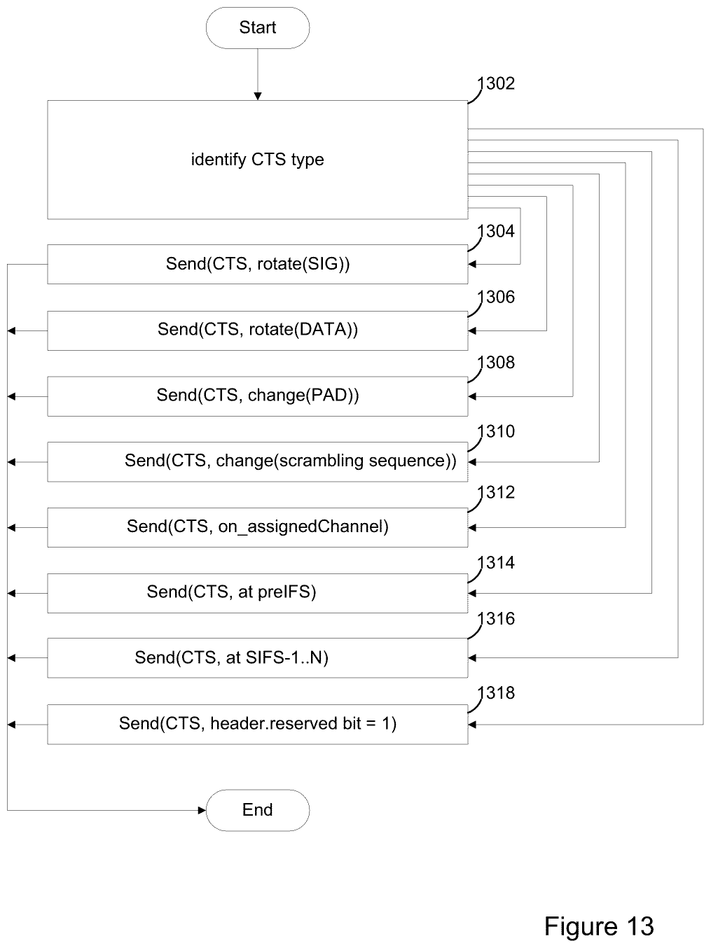

FIG. 13 depicts a flow of operations for receiving a physical frame containing a CTS frame in response to the MU-RTS frame. The flow of operations provides details for performing block 1114 in FIG. 1. In block 1302, the responding station or stations identify one or more CTS types to respond to an RTS, indicating that preemption is allowed. In block 1304, the station sends a CTS frame with a corresponding physical frame rotated SIG field. In one embodiment, the rotation is ±15-45 degrees rotation of the data subcarriers. In block 1306, the station sends a CTS frame with a corresponding physical frame rotated DATA field. In one embodiment, the rotation is ±15-45 degrees rotation of the data subcarriers. In block 1308, the station sends a CTS frame with a corresponding physical frame altered PAD field. In block 1310, the station sends a CTS frame with a changed scrambling sequence for the encoding scrambler. In block 1312, the station sends a CTS frame on a particular assigned channel. In block 1314, the station sends a CTS frame at the preIFS time. In block 1316, the station sends a CTS frame at one of the SIFS slot times. In block 1318, the station sends a CTS frame in which the reserved bit of the header is set to a 1.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer-readable medium(s) having computer readable program code embodied thereon.

Program code embodied on a computer-readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer-implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for preempting a transmission opportunity (TxOp), the method comprising:
sending, from an access point (AP), a request-to-send (RTS) frame to a plurality of stations, the AP having a pending transmission opportunity (TxOp), wherein a physical frame containing the RTS frame indicates that the AP allows having its pending TxOp to be preempted by at least one station of the plurality of stations having a TxOp with a priority higher than the pending TxOp to transfer; and
receiving a physical frame containing a clear-to-send (CTS) frame from at least one station of the plurality of stations, wherein the physical frame containing the CTS frame indicates that at least one station is preempting the TxOp of the AP.

2. The method of claim 1, wherein the RTS frame is a single-user RTS (SU-RTS) frame.

3. The method of claim 1, wherein the RTS frame is a multi-user RTS (MU-RTS) frame.

4. The method of claim 3, wherein a physical frame containing the MU-RTS frame indicates that the AP allows its pending TxOp to be preempted by altering an L-SIG field in the physical frame containing the MU-RTS frame.

5. The method of claim 3,
wherein a short interframe space (SIFS) and a preemptive IFS (preIFS) are set, the prelFS being shorter than the SIFS; and
wherein the MU-RTS frame indicates a first set of stations that are to use the preIFS, a second set of stations that are to use the SIFS, and a third set of stations that is subject to carrier sense (CS) before sending a special physical frame containing a CTS response frame, in order to indicate that preemption is allowed.

6. The method of claim 5, wherein the AP yields its pending TxOp to one of the third set of stations, which sends the special physical frame containing the CTS response frame.

7. The method of claim 5, wherein a specially-timed physical frame containing the CTS response frame is sent at a time earlier than the preIFS or the SIFS.

8. The method of claim 5,
wherein a plurality of slot times following the SIFS are set;
wherein each slot time of the plurality of slot times is assigned to a station that has received permission to preempt the pending TxOp of the AP; and
wherein each station preempting the pending TxOp of the AP sends a physical frame containing the CTS frame to the AP.

9. An access point comprising
a processor; and
a memory coupled to the processor and having loaded therein a program which, when executed by the processor, is configured to:
send, from an access point (AP), a request-to-send (RTS) frame to a plurality of stations, the AP having a pending transmission opportunity (TxOp), wherein a physical frame containing the RTS frame indicates that the AP allows having its pending TxOp to be preempted by at least one station of the plurality of stations having a TxOp with a priority higher than the pending TxOp to transfer; and
receive a physical frame containing a clear-to-send (CTS) frame from at least one station of the plurality of stations, wherein the physical frame containing the CTS frame indicates that at least one station is preempting the TxOp of the AP.

10. The access point of claim 9, wherein the RTS frame is a single-user RTS (SU-RTS) frame.

11. The access point of claim 9, wherein the RTS frame is a multi-user RTS (MU-RTS) frame.

12. The access point of claim 11, wherein a physical frame containing the MU-RTS frame indicates that the AP allows its pending TxOp to be preempted by altering an L-SIG field in the physical frame containing the MU-RTS frame.

13. The access point of claim 11,
wherein a short interframe space (SIFS) and a preemptive IFS (preIFS) are set, the preIFS being shorter than the SIFS; and
wherein the MU-RTS frame indicates a first set of stations that are to use the preIFS, a second set of stations that are to use the SIFS, and a third set of stations that is subject to carrier sense (CS) before sending a special physical frame containing a CTS response frame,
in order to indicate that preemption is allowed.

14. The access point of claim 13, wherein the AP yields its pending TxOp to one of the third set of stations, which sends the special physical frame containing the CTS response frame.

15. The access point of claim 13, wherein a specially-timed physical frame containing the CTS response frame is sent at a time earlier than the preIFS or the SIFS.

16. The access point of claim 13,
wherein a plurality of slot times following the SIFS are set;
wherein each slot time of the plurality of slot times is assigned to a station that has received permission to preempt the pending TxOp of the AP; and
wherein each station preempting the pending TxOp of the AP sends a physical frame containing the CTS frame to the AP.

17. A non-transitory computer-readable medium encoding instructions, which, when executed by a processor of an access point (AP) coupled to a wireless medium, cause the AP to:
send, from an AP, a request-to-send (RTS) frame to a plurality of stations, the AP having a pending transmission opportunity (TxOp), wherein a physical frame containing the RTS frame indicates that the AP allows having its pending TxOp to be preempted by at least one station of the plurality of stations having a TxOp with a priority higher than the pending TxOp to transfer; and
receive a physical frame containing a clear-to-send (CTS) frame from at least one station of the plurality of stations, wherein the physical frame containing the CTS frame indicates that at least one station is preempting the TxOp of the AP.

18. The non-transitory computer-readable medium of claim 17, wherein the RTS frame is a multi-user RTS (MU-RTS) frame.

19. The non-transitory computer-readable medium of claim 18,
wherein a short interframe space (SIFS) and a preemptive IFS (preIFS) are set, the prelFS being shorter than the SIFS; and
wherein the MU-RTS frame indicates a first set of stations that are to use the preIFS, a second set of stations that are to use the SIFS, and a third set of stations that is subject to carrier sense (CS) before sending a special physical frame containing a CTS response frame, in order to indicate that preemption is allowed.

20. The non-transitory computer-readable medium of claim 19,
wherein a plurality of slot times following the SIFS are set;
wherein each slot time of the plurality of slot times is assigned to a station that has received permission to preempt the pending TxOp of the AP; and
wherein each station preempting the pending TxOp of the AP sends a physical frame containing the CTS frame to the AP.
